(19) United States
(12) Patent Application Publication
(10) Pub. No.: US 2008/0124537 A1
(43) Pub. Date: May 29, 2008

(54) Modified Surfacer Coat for Improving Non-Uniform Composite Surfaces

(75) Inventors: Kenneth W. Minks, Mulvane, KS (US); Larry W. Keefer, Rose Hill, KS (US); Leslie J. Biggs, Gray Court, SC (US)

Correspondence Address: KUTAK ROCK, LLP, 1801 CALIFORNIA STREET, SUITE 3100, DENVER, CO, 80202-2626, US

(73) Assignees: Hawker Beechcraft Corporation, Wichita, KS (US); Mankiewicz-Coatings LLC, Simpsonville, SC (US)

(21) Appl. No.: 11/743,614

(22) Filed: May 2, 2007

Related U.S. Application Data
(60) Provisional application No. 60/809,885, filed on May 31, 2006.

(51) Int. Cl. B05D 3/02; B32B 5/16; B05D 3/06

(52) U.S. Cl. 428/327; 427/385.5; 427/553

(57) ABSTRACT

A surfacer coat (300, 300′) includes a resin material (302), a plurality of first particles (306, 306′), and a plurality of second particles (308, 308′). The plurality of first particles (306, 306′) and the plurality of second particles (308, 308′) are uniformly distributed through the resin material (302). Each first particle (306, 306′) is of a preselected shape and of a size ranging from about 5 microns to about 10 microns, and each second particle (308, 308′) is of a preselected shape and of a size ranging from about 40 microns to about 50 microns.

### CROSS REFERENCE TO RELATED APPLICATION

This application claims the benefit of U.S. Provisional Patent Application Ser. No. 60/809,885, filed May 31, 2006, entitled “Modified Surfacer Coat for Improving Rough Composite Surfaces”, which is incorporated herein by reference.

### FIELD

This invention relates generally to improving non-uniform composite surfaces, and more specifically to a modified surfacer coat for improving non-uniform composite surfaces.

### BACKGROUND

Composite materials are engineered materials made from two or more constituent materials that remain macroscopically distinct within the composite material. The constituent materials are synergistically combined such that the composite material possesses characteristics that the constituent materials alone do not possess.

Composite materials contain a matrix material and a reinforcement material, each of which serve a different function. The matrix material surrounds and supports the reinforcement material, and the matrix material transfers forces applied to the composite material to the reinforcement material. The reinforcement material may be stronger than the matrix material, and the reinforcement material may provide the primary load carrying capability of the composite material. Examples of matrix materials include polyester and epoxy materials, and examples of reinforcement materials include glass, carbon, and metal. Reinforcement materials are often formed into fibers which may be woven together.

A traditional example of a composite material is a combination of mud and straw, which was used to fabricate bricks in historic times. The mud, which is the matrix material, has good compression strength but poor tensile strength. The straw, which is the reinforcement material, has good tensile strength but poor compression strength. However, when the mud and the straw are combined together into a composite material for fabricating a brick, the brick has good compression strength as well as tensile strength. Thus, the mud and straw composite material has desirable characteristics of both of its constituent materials.

A more modern example of a composite material is fiberglass. Fiberglass contains a glass reinforcement material, often in the form of a fabric weave, and a plastic matrix material. The glass reinforcement material has good tensile strength but poor shear-strength. However, when the glass reinforcement material is combined with the plastic matrix material, the resulting fiberglass composite material possesses both good shear strength as well as good tensile strength.

Composite materials often possess desirable characteristics which make them suitable for replacing traditional materials in many applications. For example, composite materials may be stronger, stiffer, and/or lighter than traditional materials. Additionally, composite materials may be formed into complex shapes more easily than can be traditional materials. Consequently, composite materials are increasingly used in place of traditional materials in many applications. For example, aircraft tail sections and boat hulls are commonly constructed of composite materials instead of aluminum.

A structure fabricated out of composite materials (“composite structure”) is generally fabricated by forming the composite materials into a desired shape. Such forming may be done by hand or by one or more automated processes. For example, composite materials may be formed into the shape of an aircraft tail by use of a mold having the desired shape. After the composite materials are formed into the desired shape, the structure is cured. Curing may require that the composite structure be exposed to heat and/or pressure, such as by placing the composite structure in an autoclave.

A composite structure often has a rough or non-uniform outer surface resulting from use of a reinforcement material in the composite material. Reinforcement materials frequently have a rough, uneven surface texture, such as the weave pattern present in a reinforcement material of woven fabric. A reinforcement material's non-uniform surface texture often transfers to the composite structure's outer surface. For example, if the reinforcement material consists of a woven fabric, the woven fabric's weave pattern may transfer to the composite structure's outer surface.

A reinforcement material's location within the composite structure in relation to the structure's outer surface may also be a factor contributing to non-uniformity in the structure's outer surface texture, For example, if a woven fabric reinforcement material is located just below a composite structure's outer surface, the woven fabric's weave pattern may transfer to the composite structure's outer surface.

Shrinking of the matrix material may also contribute to surface irregularities in a composite structure's outer surface. Matrix materials generally shrink during curing, and some matrix materials require months to fully cure, As a matrix material shrinks, its thickness decreases. Consequently, a matrix material's ability to conceal a reinforcement material's irregular surface texture diminishes as the matrix material shrinks.

A composite structure having a non-uniform or irregular outer surface may be unacceptable in many applications from a performance perspective, a cosmetic perspective, of both. For example, a composite aircraft panel or a composite boat hull typically must have a relatively smooth, uniform surface to reduce drag. Additionally, customer expectations and aesthetic considerations may mandate that the aircraft or boat have a smooth outer surface. The same may be said with respect to automobile and truck bodies from an aesthetic perspective.

One prior art method of creating a uniform outer surface on a composite structure is to place a shrinkage barrier below the composite structure's outer surface, This method is disclosed in U.S. Pat. No. 5,391,425 to Isley, Jr. et al., entitled “Composite Material With Shrinkage Barrier” (“the '425 patent”). In the '425 patent, a shrinkage barrier, which includes a resin layer having microspheric particles embedded therein, is placed between reinforcement material and the outer surface of the composite structure. The shrinkage barrier blocks the reinforcement material's non-uniform surface from transferring to the composite structure's outer surface. Because the shrinkage barrier is placed within the composite structure, the shrinkage barrier must be placed in the composite structure during its fabrication. Consequently, the shrinkage barrier may not be used to create a uniform outer surface on a preexisting composite structure.

A somewhat similar prior art method of creating a uniform outer surface on a composite structure is disclosed in U.S. Pat. No. 7,022,629 to Theriault, entitled “Print Through Elimination in Fiber Reinforced Matrix Composite Mirrors and Method of Construction” (“the '629 patent”). The '629 patent discloses a method of placing a layer of small unbundled fibers between the composite material and an un-reinforced top matrix layer of a composite structure. The layer of small unbundled fibers diffuses and randomizes forces resulting from the non-uniform surface of the reinforcement materials, thereby preventing such non-uniform surface from transferring to the composite structure's outer surface. The layer of small unbundled fibers may consist of random fiber segments, a continuous fiber mat, or a weave of single or finely towed continuous fibers. However, like the method disclosed in the '425 patent, the method taught by the '629 patent can only be used during the fabrication process. Consequently, the method disclosed in the '629 patent may not be used to create a uniform outer surface on a preexisting composite structure.

Another prior art method of creating an uniform outer surface on a composite structure involves the application of one or more layers of a surfacer coat to the outer surface followed by a sanding step which is performed until a sufficiently uniform outer surface is created. A surfacer coat is a material used to prepare a surface, such as a surface of composite structure, to receive a topcoat. A surfacer coat is sometimes referred to as a sanding surfacer, a surfacer, or just a coat.

A surfacer coat may be sanded or otherwise shaped as desired after it has cured. For example, at least one layer of a surfacer coat may be applied to a composite aircraft panel, and the surfacer coat may then be sanded until the panel is sufficiently uniform. Because the surfacer coat is applied to an outer surface of a composite structure, a surfacer coat may be used to create a smooth, uniform outer surface on a preexisting composite structure.

One problem associated with prior art surfacer coats is shrinking during curing. Such shrinking may occur relatively quickly, such as over several days, or may occur relatively slowly, such as over several months. The shrinkage reduces the prior art surfacer coat's thickness and, consequently, the prior art surfacer coat's ability to create a uniform outer surface decreases as the surfacer coat shrinks. Therefore, a reinforcement material's non-uniform outer surface may transfer to a composite structure's outer surface as the prior art surfacer coat shrinks.

Hence, a need exists for a material that exhibits minimal shrinking which may be used to create a smooth, uniform outer surface on an existing composite structure.

### SUMMARY

The improved surfacer coat and applications thereof herein disclosed advance the art and overcome one or more of the problems articulated above by providing a modified surfacer coat that exhibits minimal shrinking and which may be used to create a uniform outer surface on a preexisting composite structure.

In particular, and by way of example only, a surfacer coat includes a resin material, a plurality of first particles, and a plurality of second particles. The plurality of first particles and the plurality of second particles are uniformly distributed through the resin material. Each first particle is of a size ranging from about 5 microns to about 10 microns, and each second particle is of a size ranging from about 40 microns to about 50 microns.

According to another embodiment, a structure includes at least one layer of composite material. At least one layer of primer is disposed on an outer surface of the composite material, wherein the primer includes a first resin material. At least one layer of surfacer coat is disposed on an outer surface of the primer, wherein the surfacer coat has a thickness of about at least 50 microns. The surfacer coat includes a second resin material, a plurality of first particles, and a plurality of second particles. The first particles and the second particles are uniformly distributed through the second resin material. Each first particle is of a size ranging from about 5 microns to about 10 microns, and each second particle is of a size ranging from about 40 microns to about 50 microns.

In yet another embodiment, a method of preparing an outer surface of a composite structure for receipt of a topcoat includes disposing at least one layer of primer on the outer surface of the composite structure, wherein the primer has a first resin material. At least one layer of surfacer coat is disposed on an outer surface of the primer. The surfacer coat includes a second resin material, a plurality of first particles, and a plurality of second particles, the first particles and the second particles being uniformly distributed through the second resin material. The surfacer coat is then cured.

According to another embodiment, the first and second particles uniformly distributed through the resin materials are substantially spherically shaped.

In yet another embodiment, the first and second particles uniformly distributed through the resin materials are irregularly shaped.

According to still another embodiment, the first and second particles uniformly distributed through the resin materials are substantially elliptically shaped.

In another embodiment, the first and second particles uniformly distributed through the resin materials are a mixture of irregularly shaped, substantially elliptically shaped and substantially spherically shaped particles.

### BRIEF DESCRIPTION OF THE DRAWINGS

FIG. 1 is a cross sectional view of a structure having a prior art surfacer coat layer and a topcoat layer.

FIG. 2 is a cross sectional view of the structure of FIG. 1 wherein the prior art surfacer coat layer has shrunk while curing.

FIG. 3 is a cross sectional view of a section of a modified surfacer coat, according to an embodiment.

FIG. 4 is a cross sectional view of a section of another modified surfacer coat, according to an embodiment.

FIG. 5 illustrates various particle shapes according to an embodiment.

FIG. 6 is a cross sectional view of a structure including one or more layers of a modified surfacer coat, according to an embodiment.

FIG. 7 is a cross sectional view of a structure including two layers of a modified surfacer coat, according to an embodiment.

FIG. 8 is a cross sectional view of a structure including one or more layers of another modified surfacer coat, according to an embodiment.

FIG. 9 is a cross sectional view of a structure including two layers of another modified surfacer coat, according to an embodiment.

FIG. 10 is a flow chart of a method of preparing a surface of a composite structure for receipt of a topcoat, according to an embodiment.

### DETAILED DESCRIPTION

Before proceeding with the detailed description, it is to be appreciated that the present teaching is by way of example only, not by limitation. The concepts herein are not limited to use or application with a specific type of surfacer coat. Thus, although the instrumentalities described herein are for the convenience of explanation, shown and described with respect to exemplary embodiments, it will be appreciated that the principles herein may be applied equally in other types of surfacer coats.

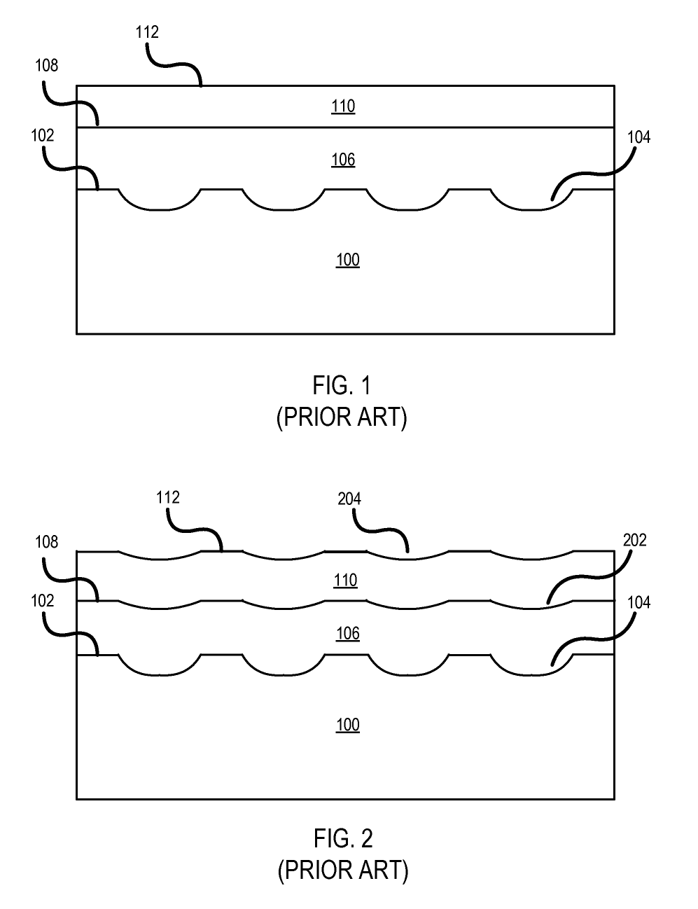

FIG. 1 illustrates the use of prior art surfacer coat 106 to smooth a non-uniform surface. FIG. 1 is a cross sectional view of composite structure 100 which includes a layer of prior art surfacer coat 106 and topcoat 110. Composite structure 100 has outer surface 102 containing deformations 104, which are caused by reinforcement material (not shown) embedded in composite structure 100. For example, deformations 104 may be caused by a weave pattern of a woven fabric reinforcement material transferring to outer surface 102. A layer of prior art surfacer coat 106, which may consist of a urethane enamel resin system filled with talc, by way of example, is applied to outer surface 102 to create outer surface 108. Outer surface 108 of prior art surfacer coat 106 may be sanded to create substantial uniformity across the entire surface. Top coat 110 is then applied to outer surface 108. Because outer surface 108 is relatively smooth, outer surface 112 of topcoat 110 will also be relatively smooth if it is applied evenly.

FIG. 2 illustrates an application wherein shrinking of prior art surfacer coat 106 creates cosmetic and/or structural defects. FIG. 2 is a cross sectional view of composite structure 100 of FIG. 1 wherein prior art surfacer coat 106 has shrunk while curing. This shrinkage results in deformations 202 being created in outer surface 108 which are caused by the presence of deformations 104 on the underlying layer. Deformations 202 are in turn transferred to outer surface 112 as deformations 204.

Deformations 204 may be considered cosmetic defects. However, deformations 202 may contribute to defects in the overall structure, inasmuch as they may cause topcoat 110 to crack or affect a change in its properties. For example, if topcoat 110 is a full gloss paint, deformations 202 may dull topcoat's 110 surface appearance.

In certain applications, deformations 204 may also be considered a structural defect, not just a cosmetic defect. For example, if composite structure 100 is part of an aircraft, the aerodynamic properties of composite structure 100 may have a substantial impact on the overall performance of the aircraft. For example, deformations 204 may disturb the airflow over the outer surface 112 while the aircraft is in flight, thus creating unwanted drag on the aircraft and heat at supersonic speeds.

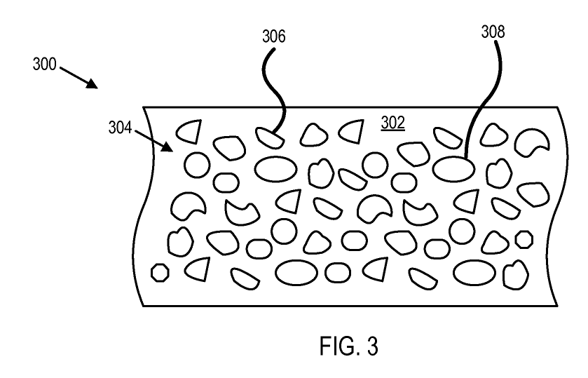

FIG. 3 is a cross sectional view of a section of modified surfacer coat 300, hereinafter referred to as surfacer coat 300. Prior to curing, surfacer coat 300 typically exists in its liquid phase at room temperatures and normal atmospheric pressure. The liquid phase may range from a state of low viscosity wherein the surfacer coat exhibits little resistance to flow to a state wherein the surfacer coat is semi-viscous. After surfacer coat 300 has cured, it transforms to the solid or semi-solid phase. In an embodiment, surfacer coat 300 is cured by drying it (e.g. by exposing it to the atmosphere), exposing it to ultraviolet radiation, exposing it to pressure, and/or heating it.

As shown in FIG. 3, surfacer coat 300 includes a plurality of particles 304 disposed within resin material 302. Preferably, particles 304 are formed from a material which undergoes little, if any, dimensional changes as it solidifies and cools. For example, particles 304 may be formed of a urethane material or a mixture of urethane and other compatible materials. If particles 304 are not susceptible to shrinking, have functionally acceptable shapes and sizes, and make up a sufficient proportion of surfacer coat 300 (e.g. at least twenty (20) percent by volume), surfacer coat 300 may exhibit little, if any, shrinking during curing. Consequently, particles 304 may help to maintain uniform coating thickness, and thereby a smooth outer surface texture as surfacer coat 300 cures.

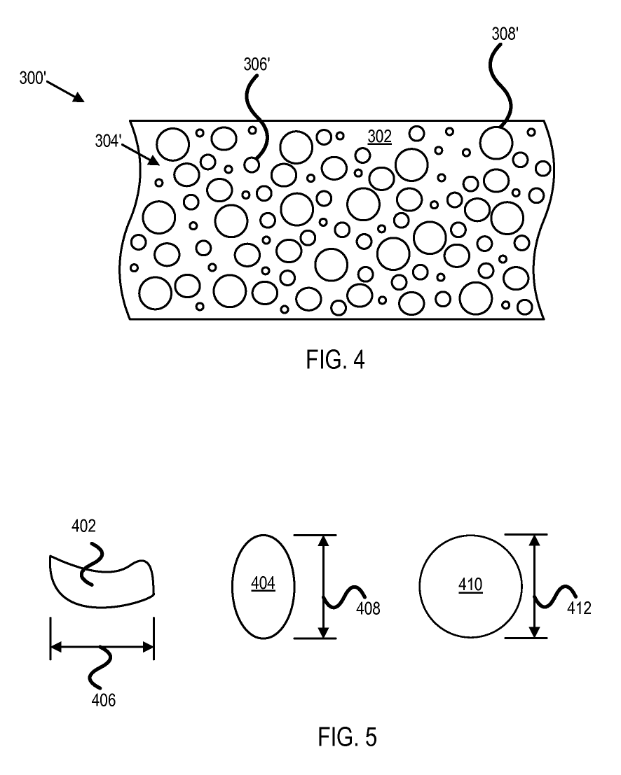

Particles 304 may be of one or more suitable sizes and shapes to effectively eliminate or minimize shrinking of surfacer coat 300 during curing. In at least one embodiment as shown in FIG. 3, particles 304 include particles of several shapes and sizes, first particles 306 and second particles 308. In another embodiment 300′ shown in FIG. 4, the plurality of particles 304′ disposed in resin material 302 are spherical or substantially spherical in shape and are present in two sizes 306′ and 308′, as discussed in greater detail below.

FIG. 5 illustrates particles of differing shapes, irregularly shaped particle 402, elliptically or egg-shaped particle 404 and spherical particle 410. The size of a particle is typically characterized by its longest dimension 406, as illustrated in FIG. 5. In an embodiment having particles 304, 304′ of two sizes, first particles 306, 306′ have a size ranging from approximately five (5) microns to approximately ten (10) microns, and second particles 308, 308′ have a size ranging from approximately forty (40) microns to approximately fifty (50) microns. Typically, of the total amount of particles contained in surfacer coat 300, 300′, approximately thirty percent (30%) to thirty-five percent (35%) by weight are first particles 306, 306′, and sixty-five percent (65%) to seventy percent (70%) by weight are second particles 308, 308′. In at least one embodiment, particles 304, 304′ may make up at least about twenty percent (20%) of surfacer coat's 300, 300′ volume.

In at least one embodiment, resin material 302 is a thermoset material. For example, resin material 302 may be a thermoset material including polycarbonate polyol urethane isocyanate resin. Thermoset materials, which are cross linked materials, resist deformation under pressure, are resistant to chemicals, and do not transform to the liquid phase when heated. In contrast, thermoplastic materials, which are not cross linked materials, deform under pressure and transform to the liquid phase when heated. Consequently, a surfacer coat formed of or containing a thermoset resin material may resist hostile environmental conditions, such as mechanical pressure, excessive heat, and chemical exposure better than a surfacer coat formed of a thermoplastic resin material. For example, when a surfacer coat having a thermoset resin material is exposed to hot sunlight, the surfacer coat will generally remain solid and thereby maintain a uniform surface. In contrast, when a surfacer coat having a thermoplastic resin material is exposed to hot sunlight, the surfacer coat may soften and allow the non-uniform surface texture of an underlying composite material to transfer to the surfacer coat's outer surface.

At least one embodiment of surfacer coat 300 may be required to undergo environmental temperature cycling ranging from negative forty-six (−46) degrees Celsius (−50 degrees Fahrenheit) to sixty-six (66) degrees Celsius (150 degrees Fahrenheit) without experiencing excessive cracking. Additionally, at least one embodiment is compatible with a metallic surface, allowing surfacer coat 300 to be used on both metallic and non-metallic surfaces.

In the embodiments described above, particles 304, 304′ are introduced into resin material 302 in a preselected quantity during production of surfacer coat 300, 300′. If the particles settle non-uniformly within resin material, they may be redistributed uniformly within the resin material by mechanically shaking the surfacer coat 300, 300′ prior to application for a sufficient length of time. Empirical mixing tests suggest that shaking the mixture for a period of approximately ten (10) minutes is sufficient to thoroughly mix and evenly distribute the particles throughout the resin.

The distribution of particles 304, 304′ within resin material 302 may also be maintained by mechanically stirring surfacer coat 300, 300′. For example, the resin material may be stirred with a paddle blade at a low speed during application of surfacer coat 300, 300′ to a surface to insure that particles 304, 304′ are distributed evenly throughout.

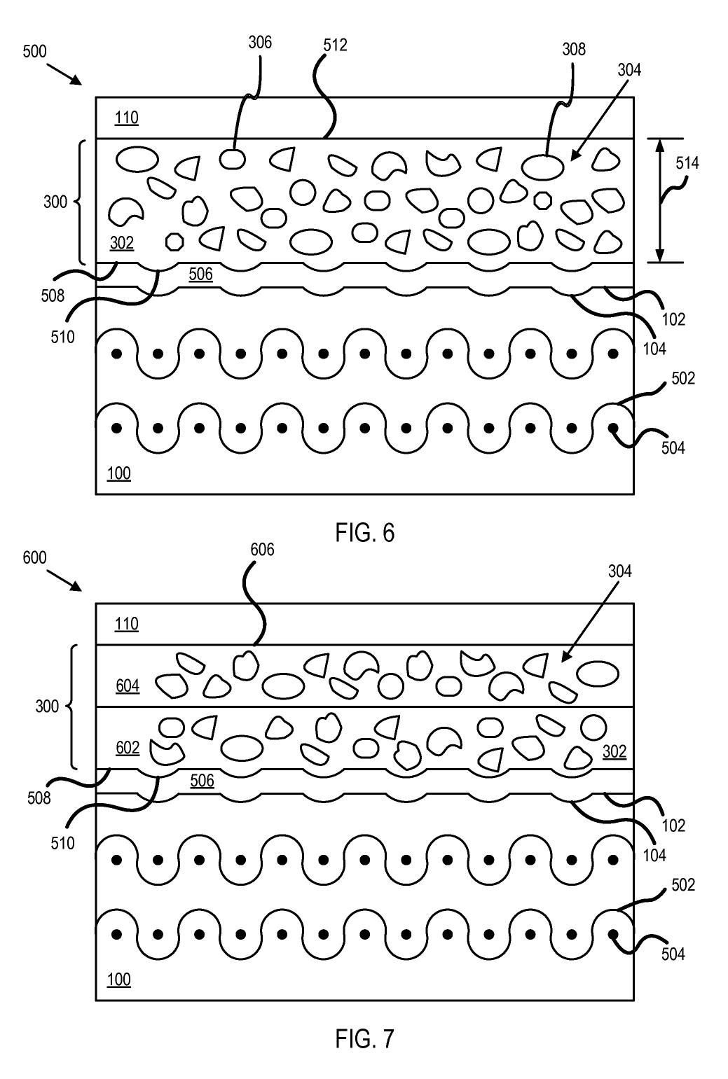

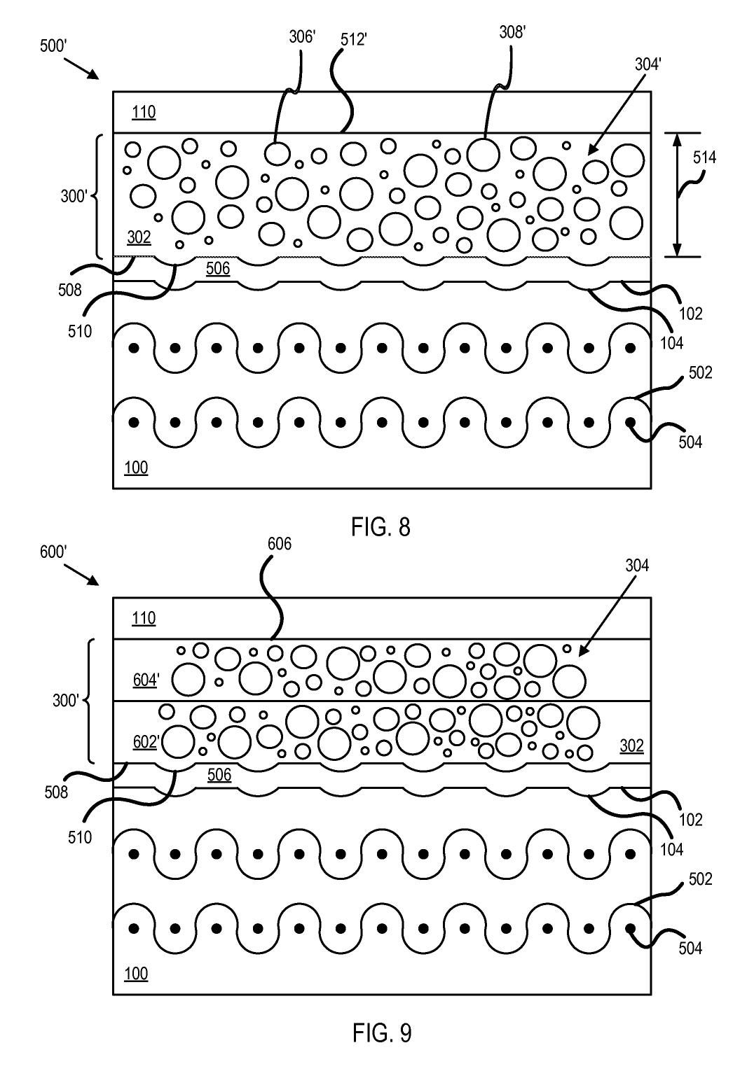

FIGS. 6 and 8 illustrate an application of surfacer coat 300, 300′, wherein surfacer coat 300, 300′ is used to create smooth, uniform surface texture on a composite structure having a non-uniform outer surface. Composite structure 100, an aircraft panel or a boat hull, by way of example, serves as a base or substrate to structure 500, 500′ and includes outer surface 102, which is non-uniform due to deformations 104.

Composite structure 100 is constructed of suitable composite materials known in the art. An embodiment of composite structure 100 includes fibers 502 and 504. Fibers 504 are disposed at approximately ninety degree angles to fibers 502, and fibers 502 and 504 are woven together in a grid configuration. Fibers 502 and 504 may be formed from glass, carbon, graphite, or other suitable materials as is known in the art. Deformations 104 depict irregularities in outer surface 102 which may appear due to use of fibers 502, 504.

In an embodiment, primer 506 is applied to outer surface 102 of composite structure 100. Primer 506 may inhibit corrosion of composite structure 100. Because primer 506 has little ability to create a uniform surface, deformations 104 may transfer as deformations 510 to top surface 508 of primer 506.

At least one layer of surfacer coat 300, 300′ is applied to top surface 508 of primer 506. In an embodiment, surfacer coat 300, 300′ has a thickness 514 of at least fifty (50) microns. If primer 506 is not used, surfacer coat 300, 300′ may be applied directly to outer surface 102 of composite structure 100. As stated above with respect to FIG. 3, surfacer coat 300, 300′ includes a plurality of particles 304, 304′ distributed in resin material 302, and particles 304, 304′ may include particles of two sizes, first particles 306, 306′ and second particles 308, 308′. In the embodiment of FIG. 6, the particles are a mixture of irregularly shaped, substantially elliptical or egg-shaped and substantially spherically shaped particles. In at least one embodiment, the particles are added in predetermined proportions. FIGS. 8 and 9 provide at least one preferred embodiment in which the particles are spherical. Resin material 302 may also be included in primer 506 in order to help insure compatibility between primer 506 and surfacer coat 300, 300′.

In an embodiment, topcoat 110 is disposed over surfacer coat 300. In at least one embodiment, topcoat 110 may be epoxy or urethane paint.

As stated above, particles 304, 304′ may cause surfacer coat 300, 300′ to exhibit minimal shrinking during its curing. Consequently, particles 304, 304′ may allow surfacer coat 300, 300′ to maintain a uniform outer surface 512, 512′ during curing of surfacer coat 300, 300′. Because surfacer coat 300, 300′ may be applied to an outer surface of a composite structure, the surfacer coat may be used to create a uniform surface on a preexisting composite structure.

Lightning resistance of structure 500, 500′ may be critical when it is used in an outdoor application. For example, as stated above, structure 500 may be an aircraft panel. An aircraft may be in danger from being struck by lightning either when it is airborne or when it is located on the ground. If an aircraft panel were to experience structural failure as the result of a lightning strike, the consequences could be catastrophic.

Insuring that structure 500, 500′ has sufficient lightning resistance is challenging because composite structure 100 is a relatively a poor conductor of electricity. Consequently, if composite structure 100 is struck by lightning, the energy associated with the lighting strike does not distribute itself over composite structure 100, as the energy would do if composite structure 100 were a metallic structure. Instead, the energy remains in the area of contact by the lightning and may cause composite structure 100 to experience structural failure. In order to prevent such structural failure, it is critical that structure 500, 500′ allow lightning energy to reflect off composite structure 100.

The combined thickness of primer 506, surfacer coat 300, 300′, and topcoat 110 affects whether lightning energy will be able to reflect off composite structure 100. When lightning strikes structure 500, 500′, lightning energy will penetrate topcoat 110, surfacer coat 300, 300′, and primer 506. In order to allow the lightning energy to reflect off composite structure 100, the combined thickness of primer 506, surfacer coat 300, 300′, and topcoat 110 must be sufficiently small. Stated simply, decreasing the combined thickness of primer 506, surfacer coat 300, 300′, and topcoat 110 increases the ability of composite structure 100 to survive a lightning strike.

Empirical tests have shown that a composite structure will have reasonable lightning resistance if a layer of surfacer coat disposed on the composite structure has a thickness of about one hundred seventy-eight (178) microns (7.00 mils) or less. Surfacer coat 300, 300′ may provide an uniform surface when applied in one or more layers having thickness 514 as low as fifty (50) microns (1.97 mils), and in an embodiment, surfacer coat 300, 300′ has thickness ranging from fifty (50) microns (1.97 mils) to one hundred seventy-eight (178) microns (7.00 mils) Additionally, in an embodiment, a combined thickness of primer 506, surfacer coat 300, 300′, and topcoat 110 does not exceed two hundred sixteen (216) microns (8.5 mils). Consequently, surfacer coat 300, 300′ may be used in composite structure applications requiring adequate lightning resistance. Additionally, because surfacer coat 300 may have thickness 514 as low as fifty (50) microns (1.97 mils), surfacer coat 300 may be used in applications that require a relatively thin layer of surfacer coat to minimize its weight. An example of such an application is an aircraft application wherein it is desirable to minimize the weight of a surfacer coat in order to maximize aircraft fuel economy.

FIG. 7 and 9 cross sectional views of a structure 600,600′ including two layers of surfacer coat, collectively surfacer coat 300,300′. Structures 600, 600′, which are alternative embodiments of structures 500, 500′, respectively, exemplify another application of surfacer coat 300. In structure 600, 600′, surfacer coat 300, 300′ includes two discrete layers, 602, 602′ and 604, 604′, respectively. The resin material of one of the layers is color tinted, and the resin material of the other layer is untinted. The color tinted layer of surfacer coat 300, 300′ has a different color than the un-tinted layer of surfacer coat 300, 300′. Color tinting allows an operator sanding surface 606, 606′ of surfacer coat 300, 300′ to determine when outer layer 604 has been sanded off. The operator will be able to recognize that outer layer 604, 604′ has been sanded off because the color of surfacer coat 300 will change. Use of color tinted and un-tinted layers of surfacer coat 300 may be helpful in applications where it is desirable to allow for sanding of an outer surface (e.g. layer 604) while insuring that a minimum thickness of surfacer coat 300 (e.g. layer 602) remains on a structure.

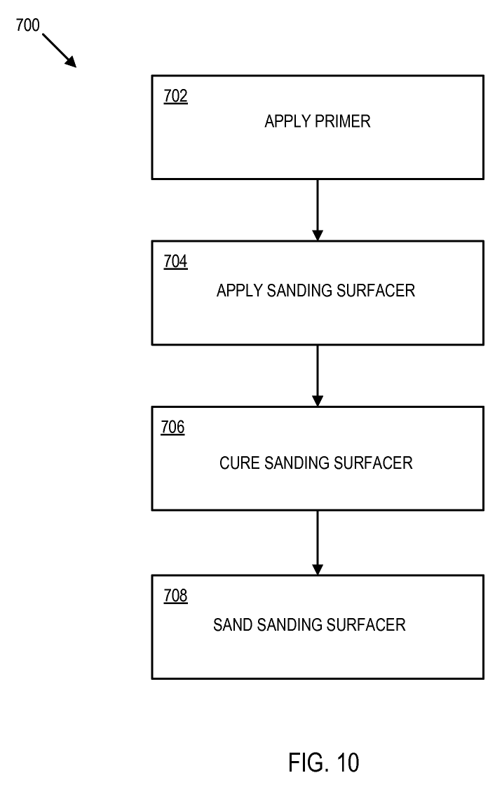

FIG. 10 is a flow chart of method 700 of preparing a surface of a composite structure for receipt of a top coat using surfacer coat 300, 300′. The composite structure may be a preexisting composite structure that was fabricated before the execution of method 700. Method 700 begins with step 702 wherein at least one layer of primer 506 is applied to an outer surface of the composite structure. As stated above, the primer may function to inhibit corrosion of the composite structure.

In step 704, at least one layer of un-cured surfacer coat 300, 300′ is applied to an outer surface of primer 506. As stated above, surfacer coat 300, 300′ exists in its liquid phase before it is cured. For example, surfacer coat 300, 300′ may be applied to the outer surface of primer 506 via a paint brush or a spray apparatus. Surfacer coat 300 includes a plurality of particles 304 to help prevent shrinking of surfacer coat 300 during its curing, and particles 304 may include particles of two sizes, first particles 306 and second particles 308, as shown in FIG. 6. In an embodiment illustrated in FIG. 8, surfacer coat 300′ includes a plurality of substantially spherically shaped particles 304′ which may include particles of two sizes, first particles 306′ and second particles 308′.

In step 706, the at least one layer of un-cured surfacer coat 300, 300′ is cured. Surfacer coat 300, 300′ is cured by a method appropriate for resin material 302. For example, surfacer coat 300, 300′ may cured by drying it (e.g. by exposing it to the atmosphere), by exposing it to ultraviolet radiation, by exposing it to pressure, and/or by heating it. Step 708 is an optional step. In step 708, after surfacer coat 300, 300′ has cured, it is sanded until an outer layer of surfacer coat 300, 300′ achieves a predetermined uniformity in surface texture. A topcoat can applied after step 708, or a topcoat can be applied after step 706 if step 708 is not to be executed.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A surfacer coat, comprising:
a resin material;
a plurality of first particles, each first particle having a preselected shape and a size ranging from about 5 microns to about 10 microns, the plurality of first particles uniformly distributed through the resin material; and
a plurality of second particles, each second particle having a preselected shape and a size ranging from about 40 microns to about 50 microns, the plurality of second particles uniformly distributed through the resin material.

2. The surfacer coat of claim 1, wherein a weight of the plurality of first particles is approximately 30 percent to 35 percent of a combined weight of the plurality of first particles and the plurality of second particles.

3. The surfacer coat of claim 1, wherein a weight of the plurality of second particles is approximately 65 percent to 70 percent of a combined weight of the plurality of first particles and the plurality of second particles.

4. The surfacer coat of claim 1, wherein at least about 20 percent of a volume of the surfacer coat results from a combined volume of the plurality of first particles and the plurality of second particles.

5. The surfacer coat of claim 1, wherein the first particles and the second particles further comprise a urethane material.

6. The surfacer coat of claim 1, wherein the first particles and the second particles are non-shrinking.

7. The surfacer coat of claim 1, wherein the resin material is a thermoset material.

8. The surfacer coat of claim 1, wherein the resin material further comprises a polycarbonate polyol urethane isocyanate resin.

9. The surfacer coat of claim 1, wherein the first particles and the second particles have a substantially spherical shape.

10. The surfacer coat of claim 1, wherein the first particles and the second particles have a substantially elliptical shape.

11. The surfacer coat of claim 1, wherein the first particles and the second particles have an irregular shape.

12. A structure, comprising:
at least one layer of composite material;
at least one layer of primer disposed on an outer surface of the composite material, the primer including a first resin material; and
at least one layer of surfacer coat disposed on an outer surface of the primer, the surfacer coat having a thickness of about at least 50 microns, the surfacer coat including:
a second resin material;
a plurality of first particles, each first particle having a preselected shape and a size ranging from about 5 microns to about 10 microns; and
a plurality of second particles, each second particle having a preselected shape and a size ranging from about 40 microns to about 50 microns, the first particles and the second particles uniformly distributed through the second resin material.

13. The structure of claim 12, wherein the first resin material is the same as the second resin material.

14. The structure of claim 12, wherein the first resin material and the second resin material are thermoset materials.

15. The structure of claim 12, wherein the first resin material and the second resin material further comprise a polycarbonate polyol urethane isocyanate resin.

16. The structure of claim 12, further comprising a topcoat disposed on an outer surface of the surfacer coat.

17. The structure of claim 12, wherein the thickness of the surfacer coat ranges from about 50 microns to about 178 microns.

18. The structure of claim 12, wherein the surfacer coat further comprises a layer of colors tinted surfacer coat and a layer of un-tinted surfacer coat.

19. The structure of claim 12, wherein the first particles and the second particles further comprise a urethane material.

20. The structure of claim 12, wherein a weight of the plurality of first particles is about equal to 30 percent to 35 percent of a combined weight of the plurality of first particles and the plurality of second particles.

21. The structure of claim 12, wherein a weight of the plurality of second particles is about equal to 65 percent to 70 percent of a combined weight of the plurality of first particles and the plurality of second particles.

22. The structure of claim 12, wherein at least about 20 percent of a volume of the surfacer coat results from a combined volume of the plurality of first particles and the plurality of second particles.

23. The structure of claim 12, wherein the structure is an aircraft element.

24. The structure of claim 12, wherein the structure is a boat element.

25. The surfacer coat of claim 12, wherein the first particles and the second particles have a substantially spherical shape.

26. The surfacer coat of claim 12, wherein the first particles and the second particles have a substantially elliptical shape.

27. The surfacer coat of claim 12, wherein the first particles and the second particles have an irregular shape.

28. A method of preparing an outer surface of a composite structure for receipt of a topcoat, comprising:
disposing at least one layer of primer on the outer surface of the composite structure, the primer having a first resin material;
disposing at least one layer of surfacer coat on an outer surface of the primer, the surfacer coat including a second resin material, a plurality of first particles having a preselected shape, and a plurality of second particles having a preselected shape, the first particles and the second particles uniformly distributed through the second resin material; and
curing the surfacer coat.

29. The method of claim 25, wherein curing is selected from the group consisting of: drying, ultraviolet radiation exposure, heating, exposure to high pressure, and combinations thereof.

30. The method of claim 25, wherein the first resin material is the same as the second resin material.

31. The method of claim 25, wherein the first resin material and the second resin material are thermoset materials.

32. The method of claim 25, wherein the first particles and the second particles further comprise a urethane material.

33. The method of claim 25, wherein the composite structure is a preexisting composite structure.

34. The method of claim 28, wherein the first particles and the second particles may be redistributed within the second resin material by mechanical shaking the surfacer coat.

35. The method of claim 28, wherein a uniform distribution of the first particles and the second particles in the second resin material maybe maintained by mechanically stirring the surfacer coat.
